(19) United States
(12) Patent Application Publication
(10) Pub. No.: US 2006/0146366 A1
(43) Pub. Date: Jul. 6, 2006

(54) Apparatus and method for enhancing image quality of a mobile communication terminal

(75) Inventor: Sung-Bong Jang, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/319,467

(22) Filed: Dec. 29, 2005

(30) Foreign Application Priority Data
Dec. 30, 2004 (KR) 10-2004-117374

(51) Int. Cl. G06F 3/12

(52) U.S. Cl. 358/1.15

(57) ABSTRACT

An apparatus and method are provided for enhancing image quality of a mobile communication terminal. The mobile communication terminal includes an image sensor that converts image data captured by a camera lens into first image data. The image sensor outputs the converted first image data. The mobile communication terminal also includes a graphic acceleration chip that converts the outputted first image data into second image data of an image suitable to be displayed on a preview screen. The mobile communication terminal further includes a CPU (Central Processing Unit) that converts the outputted first image data into second image data of an image suitable to be displayed on a video screen.

This application claims the benefit of Korean Application No. 10-2004-117374, filed on Dec. 30, 2004, which is hereby incorporated by reference in its entirety.

### BACKGROUND OF THE INVENTION

1. Field of the Invention

The present invention relates to a mobile communication terminal. More particularly, the present invention relates to enhancing image quality of an image displayed on a preview screen of a mobile communication terminal.

2. Background Information

Advances in mobile communication terminals have made today's mobile communication terminals more than simple wireless communication devices. Mobile communications terminals are now sometimes provided with multimedia reproduction functionality. Further, mobile communications terminals are now sometimes configured to operate as a camera. Mobile communications terminals have become more popular as manufacturers have been able to enhance display units provided with the mobile communication terminals. The realization of high speed communications has also contributed to the popularity of mobile communications terminals as described above. As an example, a conventional mobile communications terminal may have a high resolution digital camera and a color LCD (Liquid Crystal Display) screen.

Graphic data representing a menu is displayed on the color LCD screen of the mobile communication terminal. The graphic data represents icons which show information such as reception sensitivity, battery capacity, the presence of a message, bell/vibration and the like. In addition, an image may be displayed on the mobile communication terminal. The image may be an image inputted by a camera or streaming image data decoded by a moving picture experts group-4 (MPEG-4) coder and decoder (codec). The construction of a conventional apparatus that processes image data of a general mobile communication terminal will be described with reference to FIG. 1.

FIG. 1 is a view showing an apparatus that processes image data of a mobile communication terminal in accordance with the related art. As shown in FIG. 1, a camera lens 1 is mounted on the mobile communication terminal. The camera lens 1 captures image data. The apparatus that processes image data of a mobile communication terminal includes an image sensor 2 that outputs captured image data as YUV image data. In the YUV color model, color is decomposed into three components of Y (Luminance), U (Cb, Chroma channel, U axis, blue component) and V (Cr: Chroma channel, V axis, red component). A central processing unit (CPU) 3 is provided that converts the output YUV image data into red-green-blue RGB image data. Finally, a liquid crystal display (LCD) 5 is provided that displays the converted RGB image data. Here, the CPU 3 processes image data of the mobile communication terminal. However, the CPU 3 is also responsible for additional functions such as a call process, a user interface (UI) process, a key input process and the like.

A process of displaying image data of a mobile communication terminal in accordance with the apparatus described above will be described briefly.

Firstly, when a camera function is executed by a user, the image sensor 2 outputs captured image data as YUV image data. The image sensor 2 transmits the captured image data through 8-bit data lines (D0˜D7). Additionally, the image sensor 2 outputs a vertical synchronizing signal (VSYNC), a horizontal synchronizing signal (HSYNC), and a signal that divides the YUV image data according to a pixel unit (PCLK (Pixel Clock)). The captured image data and signals from the image sensor 2 are output to the CPU 3.

The CPU 3 converts the outputted YUV image data into RGB image data and outputs the converted RGB image data to the display 5. The mobile communication terminal can display the RGB image data on the display 5. The CPU also can control the camera mounted on the mobile communication terminal through an inter IC bus (I2C) interface.

However, in addition to processing captured image data, the apparatus that processes image data of the mobile communication terminal also performs a general call process, a UI process and a key input process through the CPU 3. Accordingly, the processing of captured image data overloads the CPU 3.

As described above, in the apparatus that processes image data of the mobile communication terminal in accordance with the related art, image data captured by the camera is processed in the CPU, which causes the CPU to be overloaded. Thus, quality of an image being displayed is deteriorated.

### SUMMARY OF THE INVENTION

Therefore, an object of the present invention is to provide an apparatus and a method for enhancing image quality of a mobile communication terminal. According to an aspect of the present invention, a mobile communications terminal is provided which can enhance quality of an image displayed on a preview screen. A graphic acceleration chip is installed in the mobile communications terminal. The graphic acceleration chip can selectively process image data inputted by a camera.

To achieve these and other advantages and in accordance with the purpose of the present invention, as embodied and broadly described herein, there is provided an apparatus for enhancing image quality of a mobile communication terminal. The mobile communication terminal includes an image sensor that converts image data captured by a camera lens into first image data. The image sensor outputs the converted first image data. The mobile communication terminal also includes a graphic acceleration chip that receives the converted first image data and converts the received first image data into second image data. The second image data converted by the graphic acceleration chip is of an image suitable for display on a preview screen. The mobile communication terminal also includes a CPU (Central Processing Unit) that converts the outputted first image data into second image data. The second image data converted by the CPU is of an image suitable for display on a video screen.

According to an aspect of the present invention, the preview screen is a screen on which an image is displayed before a still image or a video image is captured.

According to another aspect of the present invention, the graphic acceleration chip processes still image data.

According to still another aspect of the present invention, the graphic acceleration chip includes a memory that stores the processed still image data.

According to yet another aspect of the present invention, the graphic acceleration chip controls the image sensor through an inter IC bus interface.

According to another aspect of the present invention, the first image data is YUV image data and the second image data is RGB image data.

To achieve the above-described and other advantages and in accordance with the purpose of the present invention, as embodied and broadly described herein, there is provided a graphic acceleration chip that enhances image quality of a mobile communication terminal. The graphic acceleration chip is commonly housed in a mobile communication terminal with an image sensor and a central processor. The graphic acceleration chip receives first image data from an image sensor that converts image data into the first image data. The graphic acceleration chip converts the received first image data into second image data of an image to be displayed on a preview screen. The central processor converts the first image data into second image data of an image to be displayed on a video screen.

According to an aspect of the present invention, the preview screen is a screen on which an image is displayed before a still image or a video image is captured.

According to another aspect of the present invention, the graphic acceleration chip processes still image data.

According to still another aspect of the present invention, the graphic acceleration chip includes a memory that stores the processed still image data.

According to yet another aspect of the present invention, the graphic acceleration chip controls the image sensor through an inter IC bus interface.

According to another aspect of the present invention, the first image data is YUV image data and the second image data is RGB image data.

To achieve the above-described and other advantages and in accordance with the purpose of the present invention, as embodied and broadly described herein, there is provided a method for enhancing image quality of a mobile communication terminal. The method includes converting image data captured by a camera lens into first image data. The converted first image data is output. The method also includes converting the outputted first image data into second image data through a graphic acceleration chip. The second image data is of an image suitable for display on a preview screen.

According to an aspect of the present invention, the method includes initializing units to process the image data.

According to another aspect of the present invention, the initializing includes initializing the graphic acceleration chip, initializing an I2C (Inter IC Bus) interface, and initializing an image sensor.

According to still another aspect of the present invention, the preview screen is a screen which is displayed before a still image or a video image is captured.

According to yet another aspect of the present invention, the first image data is YUV image data and the second image data is RGB image data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The present invention is further described in the detailed description that follows, by reference to the accompanying drawings by way of non-limiting examples of embodiments of the present invention, in which like reference numerals represent similar parts throughout several views of the drawings, and in which:

FIG. 1 a block diagram showing an apparatus for enhancing image quality of a mobile communication terminal in accordance with the related art;

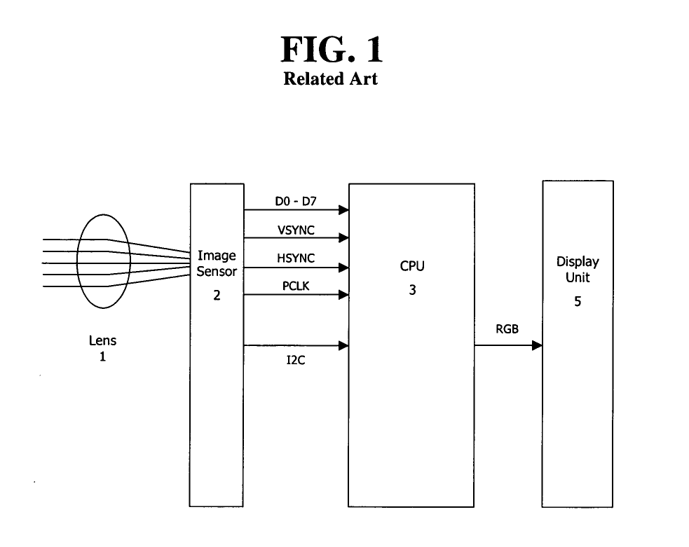

FIG. 2 is a block diagram showing an apparatus for enhancing image quality of a mobile communication terminal in accordance with the present invention; and

FIG. 3 is a flowchart showing a method for enhancing image quality of a mobile communication terminal in accordance with the present invention.

### DETAILED DESCRIPTION

Reference will now be made in detail to the preferred embodiments of the present invention, examples of which are illustrated in the accompanying drawings.

As described above, an apparatus and a method are needed for enhancing image quality of a mobile communication terminal. The apparatus and method of the present invention can enhance quality of an image displayed on a preview screen.

To achieve this and other advantages, and in accordance with the purpose of the present invention, as embodied and broadly described herein, there is provided an apparatus for enhancing image quality of a mobile communication terminal. The apparatus includes an image sensor that converts image data captured by a camera lens into first image data and outputting the converted first image data. The apparatus also includes a graphic acceleration chip that converts the outputted first image data into second image data of an image suitable for display on a preview screen. The apparatus further includes a CPU that converts the outputted first image data into second image data of an image suitable for display on a video screen.

To achieve these and other advantages and in accordance with the purpose of the present invention, as embodied and broadly described herein, there is provided a method for enhancing image quality of a mobile communication terminal. The method includes converting image data captured by a camera lens into first image data and outputting the converted first image data. The method also includes converting the outputted first image data into second image data of an image suitable for display on a preview screen through a graphic acceleration chip.

The foregoing and other objects, features, aspects and advantages of the present invention will become more apparent from the following detailed description of the present invention when taken in conjunction with the accompanying drawings.

According to an aspect of the present invention, a graphic acceleration chip is installed in a mobile communication terminal. The graphic acceleration chip selectively processes image data.

A mobile communication terminal is a device which enables communication at more than one location. Exemplary mobile communication terminals include mobile phones (cell phones) and personal digital assistants (PDAs).

A graphic acceleration chip is a type of adapter which boosts performance levels. Graphic acceleration chips are specialized for computing graphical transformations. Accordingly, graphic acceleration chips can be used to relieve the burdens of CPUs, so that a CPU executes other commands while the graphics accelerator is handling graphics computations.

In addition to a graphics processor, graphics acceleration chips may include memory which is reserved for storing graphical representations. Graphics acceleration chips may also include a bus

The graphics acceleration chip is provided to relieve the burdens imposed on a CPU when images are displayed. Hereinafter, an apparatus and a method for enhancing image quality of a mobile communication terminal are described in detail with reference to the accompanying drawings. The apparatus and method can enhance quality of an image displayed on a preview screen. A graphic acceleration chip is installed in the apparatus. The graphic acceleration chip selectively processes image data inputted by a camera.

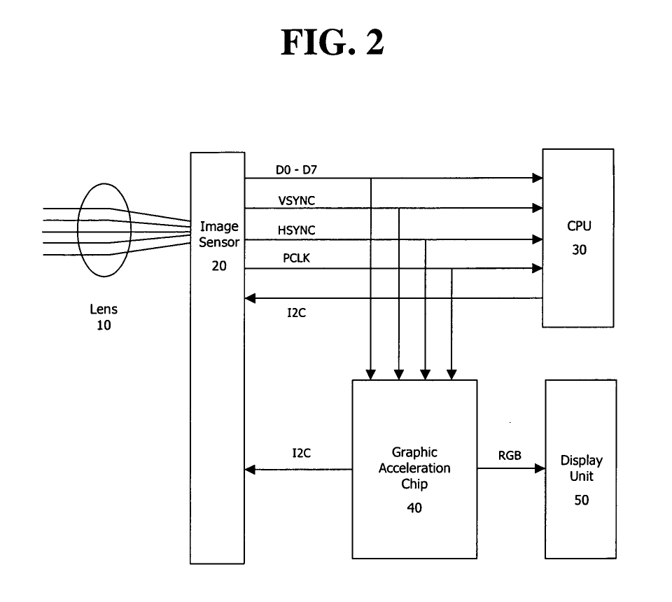

FIG. 2 is a view showing an exemplary apparatus for enhancing image quality of a mobile communication terminal in accordance with an embodiment of the present invention.

As shown in FIG. 2, the apparatus for enhancing image quality of a mobile communication terminal includes an image sensor 20 that outputs image data captured by a camera lens 10 as YUV image data. The apparatus also includes a CPU (Central Processing Unit) 30 that converts the outputted YUV image data into RGB image data of an image suitable for display on a video screen. The apparatus in FIG. 2 also includes a graphic acceleration chip 40 that converts the outputted YUV image data into RGB image data of an image suitable for display on a preview screen. The apparatus also includes a display unit 50 that displays the RGB image data converted in the graphic acceleration chip 40. Here, the preview screen is a screen which displays a preview image before a still image or a video image is captured by a camera function.

An exemplary apparatus for enhancing image quality of a mobile communication terminal will be described in detail.

A camera lens 10 is mounted on the mobile communication terminal. The camera lens 10 captures image data When the camera function is executed, the image sensor 20 converts captured image data into YUV image data. The image sensor 20 outputs the converted YUV image data to the graphic acceleration chip 40 through 8-bit data lines (D0˜D7). The image sensor 20 also outputs a vertical synchronizing signal (VSYNC), a horizontal synchronizing signal (HSYNC), and a Pixel Clock signal (PCLK) that divides the YUV image data according to a pixel unit, to the graphic acceleration chip 40.

As the graphic acceleration chip 40 converts the outputted YUV image data into RGB data and outputs the converted RGB data to the display unit 50, the mobile communication terminal displays the RGB data on the display unit 50. At this time, the graphic acceleration chip 40, and not the CPU 30, converts the image data into the RGB data. Additionally, the graphic acceleration chip 40 controls the camera mounted on the mobile communication terminal through an I2C interface.

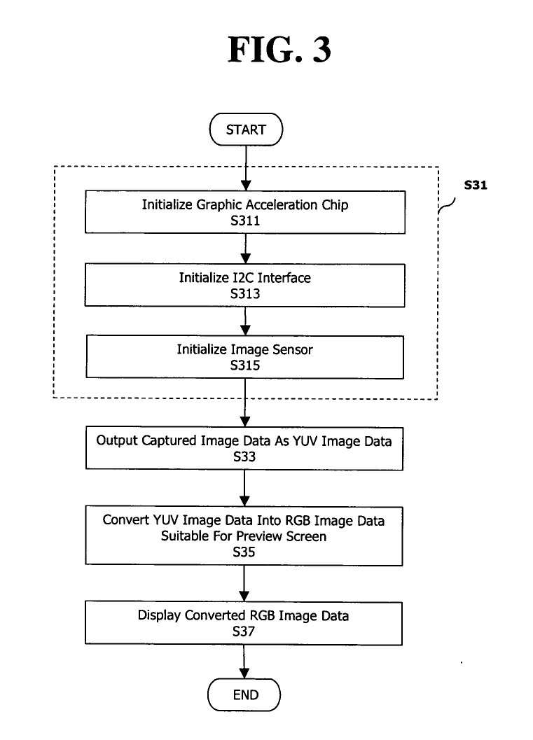

A method for enhancing image quality for the above-described mobile communication terminal will be described with reference to FIG. 3.

FIG. 3 is a flowchart showing a method for enhancing image quality of a mobile communication terminal in accordance with an exemplary embodiment of the present invention.

As shown in FIG. 3, the method for enhancing image quality of a mobile communication terminal includes initializing units to process image data (S31). Image data is captured by the initialized units, and the captured image data is output as YUV image data (S33). The outputted YUV image data is converted into RGB image data of an image suitable for display on a preview screen through a graphic acceleration chip (S35). The converted RGB image data is displayed (S37). Here, the initializing at S31 includes initializing the graphic acceleration chip (S311), initializing an I2C (Inter IC Bus; I2C) interface (S313), and initializing an image sensor (S315).

An exemplary method for enhancing image quality of the mobile communication terminal in accordance with an embodiment of the present invention will be described in detail.

First, when a camera function is selected by the user, the mobile communication terminal initializes units to process captured image data (S31). That is, the mobile communication terminal initializes the graphic acceleration chip 40 at S311. The graphic acceleration chip 40 includes, for example, a separate memory for preview screen or image data processing. The mobile communication terminal next initializes the I2C interface at S313. The I2C interface is, for example, an interface allowing the graphic acceleration chip 40 to communicate with the camera. The I2C interface is used to issue a command or transfer control data, wherein the graphic acceleration chip 40 is operated as a master and the camera as a slave.

The mobile communication terminal initializes the camera through the I2C interface. In other words, the mobile communication terminal initializes the image sensor 20. For example, resolution, brightness and the like of the image data may be initialized (S315).

The image sensor 20 converts the image data into YUV image data. The image sensor 20 outputs the converted YUV image data through the data lines (D0˜D7) to the graphic acceleration chip 40 (S33). At this time, when the camera function is selected by the user, the screen display may be (1) a preview screen display, (2) a still image screen display and (3) a video screen display. The image sensor 20 can output the converted YUV image data to the CPU 30 or the graphic acceleration chip 40 according to the camera function (screen display) selected by the user.

Accordingly, as the graphic acceleration chip 40 converts the outputted YUV image data into RGB image data and outputs the converted RGB image data (S35), the mobile communication terminal can display the outputted RGB image data on the display unit 50 (S37).

Thereafter, when a still image is captured by the user in a state that the preview screen is displayed, the apparatus can process the still image data through the graphic acceleration chip 40. The apparatus can store the processed still image data in a separate memory within the graphic acceleration chip 40. In addition, when a video image is captured, the apparatus can process the video image data by the CPU 30. The apparatus can store the video image data processed by the CPU 30 in a separate memory within the CPU 30

As described, the apparatus and the method for enhancing image quality of the mobile communication terminal can enhance quality of an image displayed on the preview screen because the burden on the CPU is decreased. The decreased burden on the CPU results from installing the graphic acceleration chip and selectively processing image data in the graphic acceleration chip. In particular, as described above the graphic acceleration chip may be selectively used to process image data for a preview screen display and/or a captured still image screen display, whereas a CPU may be selectively used to process image data for a captured video image screen display.

Although the present specification describes components and functions that may be implemented in particular embodiments with reference to particular standards, the invention is not limited to such standards. Each of the standards represent examples of the state of the art. Such standards are periodically superseded by faster or more efficient equivalents having essentially the same functions. Accordingly, replacement standards having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. As the present invention may be embodied in several forms without departing from the spirit or essential characteristics thereof, it should also be understood that the above-described embodiments are not limited by any of the details of the foregoing description, unless otherwise specified. Rather, the above-described embodiments should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. An apparatus for enhancing image quality of a mobile communication terminal, comprising:
an image sensor that converts image data into first image data;
a graphic acceleration chip that receives and converts the first image data into second image data of an image for display on a preview screen; and
a central processor that receives and converts the first image data into second image data of an image for display on a video screen.

2. The apparatus of claim 1, wherein the preview screen is a screen on which an image is displayed before a still image or a video image is captured.

3. The apparatus of claim 1, wherein the graphic acceleration chip processes still image data.

4. The apparatus of claim 3, wherein the graphic acceleration chip includes a memory that stores the processed still image data.

5. The apparatus of claim 1, wherein the graphic acceleration chip controls the image sensor through an inter IC bus interface.

6. The apparatus of claim 1, wherein the first image data is YUV image data and the second image data is RGB image data.

7. A method for enhancing image quality of a mobile communication, comprising:
converting image data captured by a camera lens into first image data and outputting the converted first image data; and
converting the outputted first image data into second image data of an image suitable for display on a preview screen through a graphic acceleration chip.

8. The method of claim 7, further comprising:
initializing units to process the image data.

9. The method of claim 8, wherein the initializing said units comprises:
initializing the graphic acceleration chip;
initializing a I2C (Inter IC Bus) interface; and
initializing an image sensor.

10. The method of claim 7, wherein the preview screen is a screen which is displayed before a still image or a video image is captured.

11. The method of claim 7, wherein the first image data is YUV image data and the second image data is RGB image data.

12. A graphic acceleration chip for enhancing image quality of a mobile communication terminal, said graphic acceleration chip being commonly housed in said mobile communication terminal with an image sensor and a central processor, said graphic acceleration chip receiving first image data from an image sensor that converts image data into the first image data, said graphic acceleration chip converting the received first image data into second image data of an image to be displayed on a preview screen and the central processor unit converting the first image data into second image data of an image to be displayed on a video screen.

13. The graphic acceleration chip of claim 12, wherein the preview screen is a screen on which an image is displayed before a still image or a video image is captured.

14. The graphic acceleration chip of claim 12, wherein the graphic acceleration chip processes still image data.

15. The graphic acceleration chip of claim 14, wherein the graphic acceleration chip includes a memory that stores the processed still image data.

16. The graphic acceleration chip of claim 12, wherein the graphic acceleration chip controls the image sensor through an inter IC bus interface.

17. The graphic acceleration chip of claim 12, wherein the first image data is YUV image data and the second image data is RGB image data.
